(19) United States
(12) Patent Application Publication
(10) Pub. No.: US 2022/0075038 A1
(43) Pub. Date: Mar. 10, 2022

(54) APPARATUS AND METHODS FOR LONG RANGE, HIGH RESOLUTION LIDAR

(71) Applicant: Velodyne Lidar USA, Inc., San Jose, CA (US)

(72) Inventors: David S. Hall, Oakland, CA (US); Mathew Rekow, Santa Cruz, CA (US); Nikhil Naikal, San Francisco, CA (US); Sunil Khatana, Sunnyvale, CA (US); Stephen S. Nestinger, Fremont, CA (US); Anand Gopalan, Foster City, CA (US)

(21) Appl. No.: 17/470,612

(22) Filed: Sep. 9, 2021

Related U.S. Application Data
(60) Provisional application No. 63/076,345, filed on Sep. 9, 2020.

(51) Int. Cl. G01S 7/4865; G01S 17/10; G01S 7/481; G02B 26/12

(52) U.S. Cl. CPC G01S 7/4865; G01S 17/10; G01S 17/931; G02B 26/12; G01S 7/4817

(57) ABSTRACT

A LiDAR system includes an optical transmitter, a scanner, a segmented optical detector including discrete sense nodes distributed along its length, and a controller. The optical transmitter can transmit a ranging signal via an optical component of the scanner. The scanner can change a position and/or orientation of the optical component after the ranging signal is transmitted. The segmented optical detector can receive the return signal corresponding to the ranging signal via the optical component after the change in the position and/or orientation of the optical component. The controller can detect a location of a return spot of the return signal based on outputs of the discrete sense nodes. The controller can determine a distance to an object that reflected the return signal based on the location of the return spot and a residual time of flight of the return signal.

### CROSS-REFERENCE TO RELATED APPLICATIONS

This application claims the benefit of and priority to U.S. Provisional Application No. 63/076,345, titled “Apparatus and Methods for Long Range, High Resolution Lidar” and filed under Attorney Docket No. VLI-056PR on Sep. 9, 2020, which is hereby incorporated by reference herein in its entirety.

### FIELD OF TECHNOLOGY

The present disclosure relates generally to apparatus and methods for providing long range, high resolution spatial data using light detection and ranging (“LiDAR”) technology, and more particularly to apparatus and methods that use triangulation-augmented time of flight measurements to improve the range and resolution of a LiDAR system.

### BACKGROUND

Light detection and ranging (“LiDAR”) systems measure the attributes of their surrounding environments (e.g., shape of a target, contour of a target, distance to a target, etc.) by illuminating the target with pulsed laser light and measuring the reflected pulses with sensors. Differences in laser return times and wavelengths can then be used to make digital, three-dimensional (“3D” representations of a surrounding environment. LiDAR technology may be used in various applications including autonomous vehicles, advanced driver assistance systems, mapping, security, surveying, robotics, geology and soil science, agriculture, and unmanned aerial vehicles, airborne obstacle detection (e.g., obstacle detection systems for aircraft), etc. Depending on the application and associated field of view, multiple channels or laser beams may be used to produce images in a desired resolution. A LiDAR system with greater numbers of channels can generally generate larger numbers of pixels.

In a multi-channel LiDAR device, optical transmitters are paired with optical receivers to form multiple “channels.” In operation, each channel's transmitter emits an optical signal (e.g., laser) into the device's environment and detects the portion of the signal that is reflected back to the channel's receiver by the surrounding environment. In this way, each channel provides “point” measurements of the environment, which can be aggregated with the point measurements provided by the other channel(s) to form a “point cloud” of measurements of the environment.

The measurements collected by a LiDAR channel may be used to determine the distance (“range”) from the device to the surface in the environment that reflected the channel's transmitted optical signal back to the channel's receiver. The range to a surface may be determined based on the time of flight of the channel's signal (e.g., the time elapsed from the transmitter's emission of the optical signal to the receiver's reception of the return signal reflected by the surface).

Alternatively, the range from the LiDAR device to the point of reflection may be determined using triangulation. Referring to FIG. 1, the range R from a LiDAR transmitter 12 to a point of reflection 14 can be determined based on (1) the distance X between the transmitter 12 and the LiDAR receiver 16, (2) the angle α of the transmitted optical signal 18 relative to a line segment 20 connecting the transmitter and receiver, and (3) the angle β of the reflected optical signal 22 relative to the line segment 20. More specifically, by the law of sines, R=X sin β/sin (α+β). However, measuring the distance X and the angles α and β with precision can be difficult.

In some cases, LiDAR measurements may be used to determine the reflectance of the surface that reflects an optical signal. The reflectance of a surface may be determined based on the intensity on the return signal, which generally depends not only on the reflectance of the surface but also on the range to the surface, the emitted signal's glancing angle with respect to the surface, the power level of the channel's transmitter, the alignment of the channel's transmitter and receiver, and other factors.

“Laser safety” generally refers to the safe design, use and implementation of lasers to reduce the risk of laser accidents, especially those involving eye injuries. The energy generated by the laser(s) of a LiDAR system may be in or near the optical portion of the electromagnetic spectrum. Even relatively small amounts of laser light can lead to permanent eye injuries. Moderate and high-power lasers are potentially hazardous because they can burn the retina or cornea of the eye, or even the skin. The coherence and low divergence angle of laser light, aided by focusing from the lens of an eye, can cause laser radiation to be concentrated into an extremely small spot on the retina. Sufficiently powerful lasers in the visible to near infrared range (400-1400 nm) can penetrate the eyeball and may cause heating of the retina.

### SUMMARY

According to an aspect of the present disclosure, a LiDAR-based sensor system includes an optical transmitter, a scanner, a segmented optical detector including a plurality of discrete sense nodes distributed along a length of the segmented optical detector, and a controller. The optical transmitter is operable to transmit a ranging signal via an optical component of the scanner. The scanner is operable to change a position and/or orientation of the optical component after the ranging signal is transmitted via the optical component and before a return signal corresponding to the ranging signal is received. The segmented optical detector is operable to receive the return signal corresponding to the ranging signal via the optical component after the change in the position and/or orientation of the optical component, and the controller is operable to detect a location of a return spot of the return signal based on outputs of one or more of the discrete sense nodes. The controller is operable to determine a distance to an object that reflected the return signal based on the location of the return spot and a residual time of flight of the return signal.

According to an aspect of the present disclosure, a LiDAR-based sensing method includes, by an optical transmitter and via an optical component of a scanner of a LIDAR device, transmitting a ranging signal toward a first scan point of a plurality of scan points; changing a position and/or orientation of the optical component of the scanner after the ranging signal is transmitted via the optical component; after changing the position and/or orientation of the optical component of the scanner, receiving a return signal reflected from the first scan point, wherein the return signal is received via the optical component of the scanner and by a segmented optical detector including a plurality of discrete sense nodes distributed along a length of the segmented optical detector; detecting, by a controller, a location of a return spot of the return signal based on outputs of one or more of the discrete sense nodes; and determining, by the controller, a distance to the first scan point based on the location of the return spot and a residual time of flight of the return signal.

According to an aspect of the present disclosure, a method includes, by a segmented optical detector including a plurality of discrete sense nodes distributed along a length of the segmented optical detector, generating a plurality of electrical signals during a ranging period of a scan point, wherein each electrical signal in the plurality of electrical signals corresponds to a respective discrete sense node in the plurality of discrete sense nodes and represents an optical signal sensed by the respective discrete sense node; and by a controller: receiving the plurality of electrical signals generated by the segmented optical detector; sampling the plurality of electrical signals of the segmented optical detector at multiple times during the ranging period, thereby generating a plurality of sampled values; determining, based on the plurality of sampled values, whether the segmented optical detector has received a return spot; and when the controller determines that the segmented optical detector has received the return spot, determining which of the plurality of discrete sense nodes of the segmented optical detector received the return spot; determining a residual time of flight of a return signal corresponding to the return spot; and determining a distance to a scan point from which the return signal was reflected based on which of the plurality of discrete sense nodes received the return spot and the residual time of flight of the return signal.

According to an aspect of the present disclosure, a LIDAR-based receiver system includes a segmented optical detector including a plurality of discrete sense nodes distributed along a length of the segmented optical detector and an optical controller. The segmented optical detector is configured to generate a plurality of electrical signals during a ranging period of a scan point, wherein each electrical signal in the plurality of electrical signals corresponds to a respective discrete sense node in the plurality of discrete sense nodes and represents an optical signal sensed by the respective discrete sense node. The controller configured to: receive the plurality of electrical signals generated by the segmented optical detector; sample the plurality of electrical signals of the segmented optical detector at multiple times during the ranging period, thereby generating a plurality of sampled values; determine, based on the plurality of sampled values, whether the segmented optical detector has received a return spot; and when the controller determines that the segmented optical detector has received the return spot, determine which of the plurality of discrete sense nodes of the segmented optical detector received the return spot; determine a residual time of flight of a return signal corresponding to the return spot; and determine a distance to a scan point from which the return signal was reflected based on which of the plurality of discrete sense nodes received the return spot and the residual time of flight of the return signal.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

Figure (“FIG.”) 1 is an illustration of the operation of an example of a LiDAR system that uses triangulation to determine the range to a target.

FIG. 2A is an illustration of the operation of an example of a LiDAR system.

FIG. 2B is another illustration of the operation of an example of a LiDAR system.

FIG. 2C is an illustration of an example of a LiDAR system with an oscillating mirror.

FIG. 2D is an illustration of an example of a three-dimensional (“3D”) LiDAR system.

FIG. 3 is a block diagram of a segmented optical detector, in accordance with some embodiments.

FIG. 4A is a flow chart of a method for detecting return spots, in accordance with some embodiments.

FIG. 4B is an illustration of a method for detecting return spots, in accordance with some embodiments.

FIG. 5 is a block diagram of a long-range, high-resolution LiDAR transceiver, in accordance with some embodiments.

FIG. 6 is a block diagram of a computing device/information handling system, in accordance with some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Apparatus and methods for long range, high resolution LiDAR scans are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Terminology

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

### Motivation for and Benefits of Some Embodiments

LiDAR systems may be used for a wide variety of applications, including environmental scanning, navigation of manned or unmanned vehicles, and object detection. For fast-moving vehicles (e.g., aircraft, watercraft, etc.), it is highly beneficial for the scanning, navigation, and/or object detection system to have relatively long range, high resolution, large field of view (FOV), and high scanning rate, so that objects (e.g., hazardous objects) in the vehicle's path can be detected and collisions with such objects can be avoided. For example, some aircraft (e.g., helicopters, smaller airplanes, unmanned aerial vehicles, etc.) can suffer catastrophic damage if they collide with utility lines (e.g., power lines) or guide wires (e.g., for radio towers or utility towers). While many LiDAR systems have large fields of view and high scanning rates, such systems generally have limited range (e.g., a few hundred meters) and/or low resolution at longer ranges (e.g., ranges of 1 km or more). Accordingly, LiDAR systems with enhanced range and long-range resolution are needed.

Object detection tools may use the data gathered by LiDAR systems to automatically detect and identify objects in the environments scanned by LiDAR systems. Improved techniques for detecting and identifying objects (e.g., utility lines, guide wires, etc.) from long-range LiDAR scans are needed.

Some embodiments of the apparatus and methods described herein provide LiDAR-based scanning at relatively long range (e.g., 1 km, 1.5 km, 2 km, or greater) and high resolution (e.g., a gapless grid of scan lines). In some embodiments, utility lines, guide wires, and other hazardous objects are reliably detected and identified at ranges of 1-2 km or greater.

### Some Examples of LiDAR Systems

A light detection and ranging (“LiDAR”) system may be used to measure the shape and contour of the environment surrounding the system. LiDAR systems may be applied to numerous applications including autonomous navigation and aerial mapping of surfaces. In general, a LiDAR system emits light pulses that are subsequently reflected by objects within the environment in which the system operates. The time each pulse travels from being emitted to being received (i.e., time-of-flight, “TOF” or “ToF”) may be measured to determine the distance between the LiDAR system and the object that reflects the pulse. The science of LiDAR systems is based on the physics of light and optics.

In a LiDAR system, light may be emitted from a rapidly firing laser. Laser light travels through a medium and reflects off points of surfaces in the environment (e.g., surfaces of buildings, tree branches, vehicles, etc.). The reflected light energy returns to a LiDAR detector where it may be recorded and used to map the environment.

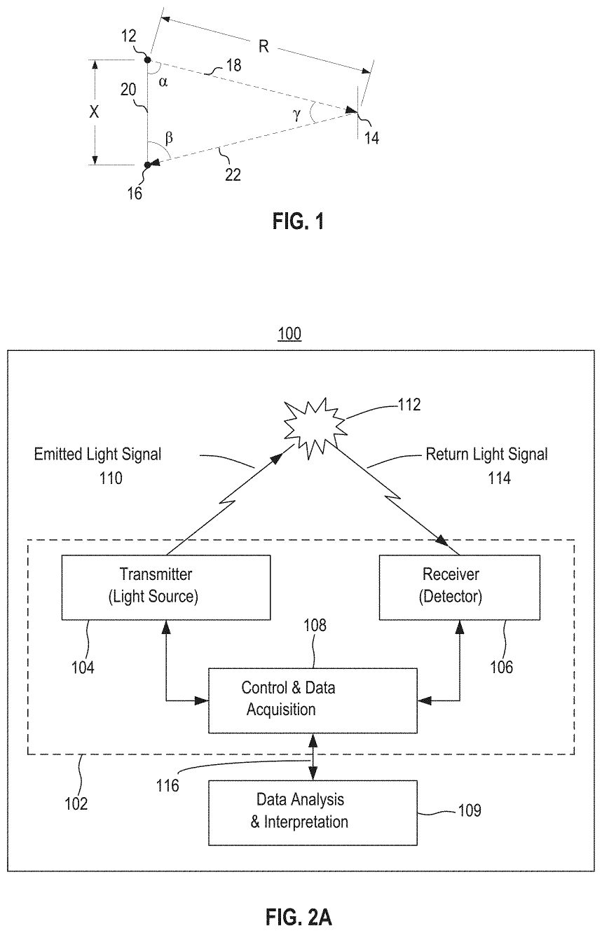

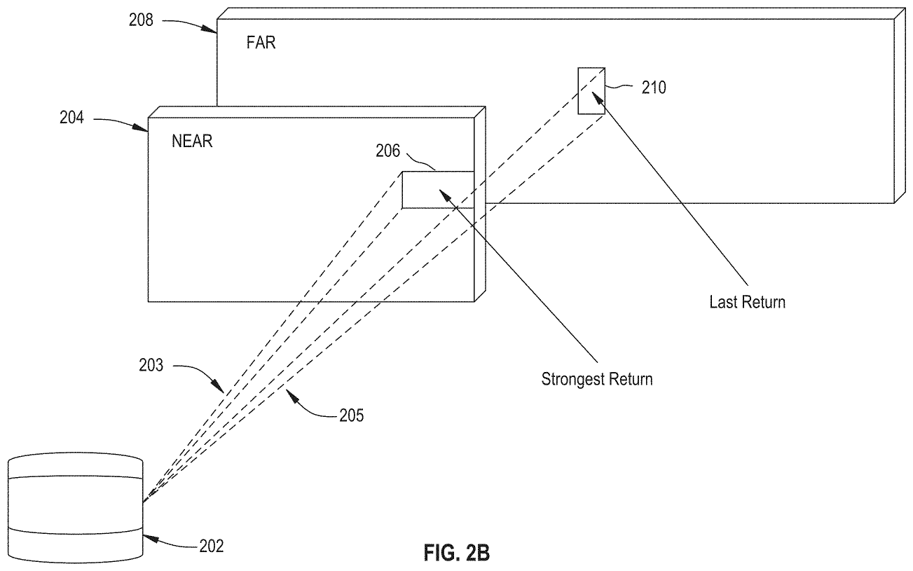

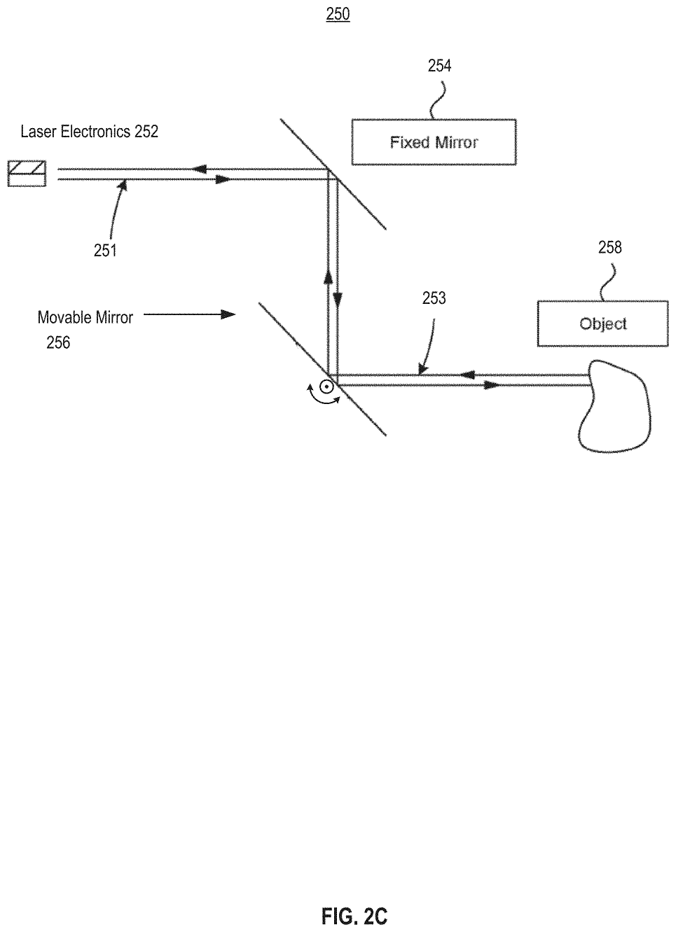

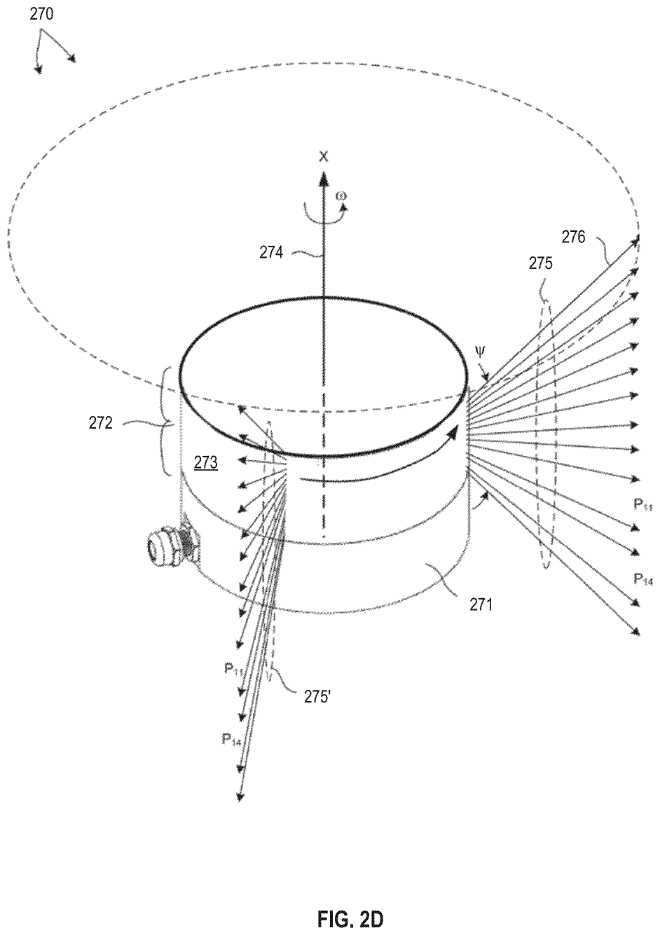

FIG. 2A depicts the operation of a LiDAR system 100, according to some embodiments. In the example of FIG. 2A, the LiDAR system 100 includes a LiDAR device 102, which may include a transmitter 104 (e.g., laser) that transmits an emitted light signal 110, a receiver 106 (e.g., photodiode) that detects a return light signal 114, and a control & data acquisition module 108. The LiDAR device 102 may be referred to as a LiDAR transceiver or “channel.” In operation, the emitted light signal 110 propagates through a medium and reflects off an object 112, whereby a return light signal 114 propagates through the medium and is received by receiver 106.

The control & data acquisition module 108 may control the light emission by the transmitter 104 and may record data derived from the return light signal 114 detected by the receiver 106. In some embodiments, the control & data acquisition module 108 controls the power level at which the transmitter operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 determines (e.g., measures) characteristics of the return light signal 114 detected by the receiver 106. For example, the control & data acquisition module 108 may measure the intensity of the return light signal 114 using any suitable technique.

A LiDAR transceiver may include one or more optical lenses and/or mirrors (not shown). The transmitter 104 may emit a laser beam having a plurality of pulses in a particular sequence. Design elements of the receiver 106 may include its horizontal field of view (hereinafter, “FOV”) and its vertical FOV. One skilled in the art will recognize that the FOV parameters effectively define the visibility region relating to the specific LiDAR transceiver. More generally, the horizontal and vertical FOVs of a LiDAR system may be defined by a single LiDAR device (e.g., sensor) or may relate to a plurality of configurable sensors (which may be exclusively LiDAR sensors or may have different types of sensors). The FOV may be considered a scanning area for a LiDAR system. A scanning mirror and/or rotating assembly may be utilized to obtain a scanned FOV.

The LiDAR system may also include a data analysis & interpretation module 109, which may receive an output via connection 116 from the control & data acquisition module 108 and perform data analysis functions. The connection 116 may be implemented using a wireless or non-contact communication technique.

FIG. 2B illustrates the operation of a LiDAR system 202, in accordance with some embodiments. In the example of FIG. 2B, two return light signals 203 and 205 are shown. Laser beams generally tend to diverge as they travel through a medium. Due to the laser's beam divergence, a single laser emission may hit multiple objects producing multiple return signals. The LiDAR system 202 may analyze multiple return signals and report one of the return signals (e.g., the strongest return signal, the last return signal, etc.) or more than one (e.g., all) of the return signals. In the example of FIG. 2A, LiDAR system 202 emits a laser in the direction of near wall 204 and far wall 208. As illustrated, the majority of the beam hits the near wall 204 at area 206 resulting in return signal 203, and another portion of the beam hits the far wall 208 at area 210 resulting in return signal 205. Return signal 203 may have a shorter TOF and a stronger received signal strength compared with return signal 205. In both single and multiple return LiDAR systems, it is important that each return signal is accurately associated with the transmitted light signal so that an accurate TOF is calculated.

Some embodiments of a LiDAR system may capture distance data in a two-dimensional (“2D”) (e.g., single plane) point cloud manner. These LiDAR systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., detector). Use of a movable (e.g., oscillating) mirror in this manner may enable the LiDAR system to achieve 90-180-360 degrees of azimuth (horizontal) view while simplifying both the system design and manufacturability. Many applications require more data than just a single 2D plane. The 2D point cloud may be expanded to form a three-dimensional (“3D”) point cloud, where multiple 2D clouds are used, each pointing at a different elevation (vertical) angle. Design elements of the receiver of the LiDAR system 202 may include the horizontal FOV and the vertical FOV.

FIG. 2C depicts a LiDAR system 250 with a movable (e.g., oscillating) mirror, according to some embodiments. In the example of FIG. 2C, the LiDAR system 250 uses a single laser emitter/detector pair combined with a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The LiDAR system 250 may have laser electronics 252, which may include a single light emitter and light detector. The emitted laser signal 251 may be directed to a fixed mirror 254, which may reflect the emitted laser signal 251 to the movable mirror 256. As movable mirror 256 moves (e.g., “oscillates”), the emitted laser signal 251 may reflect off an object 258 in its propagation path. The reflected signal 253 may be coupled to the detector in laser electronics 252 via the movable mirror 256 and the fixed mirror 254. Design elements of the receiver of LiDAR system 250 include the horizontal FOV and the vertical FOV, which defines a scanning area.

FIG. 2D depicts a 3D LiDAR system 270, according to some embodiments. In the example of FIG. 2D, the 3D LiDAR system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D LiDAR system 270 includes a LiDAR transceiver 102 operable to emit laser beams 276 through the cylindrical shell element 273 of the upper housing 272. In the example of FIG. 2D, each individual arrow in the sets of arrows 275, 275′ directed outward from the 3D LiDAR system 270 represents a laser beam 276 emitted by the 3D LiDAR system. Each beam of light emitted from the system 270 may diverge slightly, such that each beam of emitted light forms a cone of illumination light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D LiDAR system 270. The direction of each emitted beam may be determined by the angular orientation w of the transceiver's transmitter 104 with respect to the system's central axis 274 and by the angular orientation w of the transmitter's movable mirror 256 with respect to the mirror's axis of oscillation (or rotation). For example, the direction of an emitted beam in a first (e.g., horizontal) dimension may be determined the transmitter's angular orientation w, and the direction of the emitted beam in a second (e.g., vertical) dimension orthogonal to the first dimension may be determined by the angular orientation w of the transmitter's movable mirror. Alternatively, the direction of an emitted beam in a first (e.g., vertical) dimension may be determined the transmitter's angular orientation ω, and the direction of the emitted beam in a second (e.g., horizontal) dimension orthogonal to the first dimension may be determined by the angular orientation w of the transmitter's movable mirror. (For purposes of illustration, the beams of light 275 are illustrated in one angular orientation relative to a non-rotating coordinate frame of the 3D LiDAR system 270 and the beams of light 275′ are illustrated in another angular orientation relative to the non-rotating coordinate frame.)

The 3D LiDAR system 270 may scan a particular point in its field of view by adjusting the orientation ω of the transmitter and the orientation w of the transmitter's movable mirror to the desired scan point (ω, ψ) and emitting a laser beam from the transmitter 104. Likewise, the 3D LiDAR system 270 may systematically scan its field of view by adjusting the orientation ω of the transmitter and the orientation w of the transmitter's movable mirror to a set of scan points (ωᵢ, ψⱼ) and emitting a laser beam from the transmitter 104 at each of the scan points.

### Some Embodiments of Long Range, High Resolution LiDAR Systems

Assuming that the optical component(s) (e.g., movable mirror 256) of a LiDAR transceiver remain stationary during the time period after the transmitter 104 emits a laser beam 110 (e.g., a pulsed laser beam, “ranging signal,” “ranging pulse,” or “pulse”) and before the receiver 106 receives the corresponding return beam 114, the return beam generally forms a spot (e.g., “return spot”) centered at (or near) a stationary location L0 on the detector. This time period is referred to herein as the “ranging period” of the scan point associated with the transmitted beam 110 and the return beam 114.

In many LiDAR systems, the optical component(s) of a LiDAR transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location Li of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the ranging pulse. The distance between the location Li of the spot formed by the return beam and the nominal location L0 of the spot that would have been formed absent the intervening rotation of the optical component(s) during the ranging period is referred to herein as “walk-off.”

When a LiDAR transceiver 102 scans its field of view at a relatively high rate, the walk-off caused by the intervening angular motion of the scanner's optical component(s) during the ranging period of a scan point can be non-negligible, particularly when the range to the object 112 is long (e.g., 1 km or greater). Depending on the physical size of the transceiver's detector, the angular velocity of the scanner's optical component(s), and the range to the reflection point, this intervening angular motion can cause the return beam's spot to miss the transceiver's detector entirely (“walk off the detector”), such that the transceiver fails to detect the return beam.

On the other hand, if the return beam's spot does not walk off the detector, the range to the object 112 can be estimated (e.g., using triangulation) based on the walk-off of the return spot. Referring again to FIG. 1, at long distances (e.g., R>500 m), the distance R to the reflection point 14 can be estimated as the product of X and γ, where X is the walk-off of the return spot and γ is the angle through which the scanner's optical component rotates during the time-of-flight period for the transmitted optical signal 18 and the return optical signal 22.

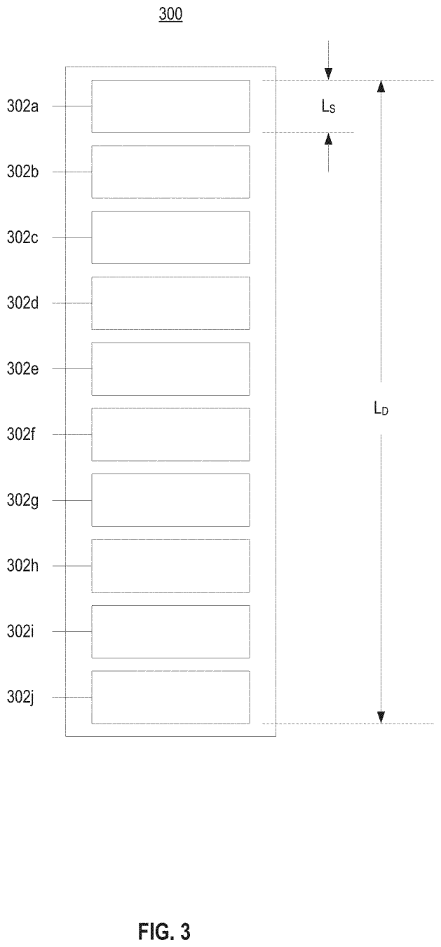

In some embodiments, the LiDAR transceiver's detector may be segmented to facilitate measurement of the return spot's walk-off. Referring to FIG. 3, a segmented detector 300 may include a plurality of detection segments 302. The detection segments 302 may be arranged linearly along the length L_{D} of the detector 300. The detector 300 may have any suitable length L_{D}, any suitable number of detection segments 302, and detection segments 302 of any suitable dimensions. Some examples of techniques for selecting the length L_{D} of the detector, the number of detection segments num_det, and the dimensions (e.g., length Ls) of the detection segments based on the desired range and other operational characteristics of the LiDAR transceiver are described below.

In operation, the detector 300 may be positioned such that (1) at least a portion of the return spot forms on the first detection segment 302a in the absence of any walk-off, and (2) as the amount of the return spot's walk-off increases, the return spot gradually migrates from the first detection segment 302a, across the intervening detection segments 302b-i, to the last detection segment 302j. The length L_{D} of the detector 300 may be selected such that the last detection segment 302j receives the return spot when the return beam is reflected by an object 112 at the transceiver's maximum range R and the transceiver is scanning its field of view at its maximum scan rate, such that the angular motion of the transceiver's optical component(s) during the scan point's ranging period is maximized.

In this configuration, the detector segment that receives the return spot depends on the range to the object that reflects the return signal. Thus, using triangulation, the distance D to an object can be estimated based on the detector segment that receives the return spot of the return signal reflected by the object as follows:

D=[det_index*R/num_det, (det_index+1)*R/num_det],

where det_index is the index of the detector segment that receives the return spot, R is the transceiver's maximum range, and num_det is the number of detector segments. The index of a given detector segment DSi may be equal to the distance between that detector segment and the first detector segment, measured in units of detector segments. (In the example of FIG. 3, the indices of detector segments 302a-302j may be 0-9, respectively.)

For example, if the maximum range of the transceiver is 1.5 km, the number of detector segments is 10 (as in the example of FIG. 3), and the detector segment 302a receives the return spot of a ranging pulse, the system can estimate the range to object that reflected the ranging pulse as [0*1.5 km/10, 1*1.5 km/10]=0 to 150 m. Likewise, if detector segment 302e receives the return spot of the ranging pulse, the system can estimate the range to the object that reflected the ranging pulse as [4*1.5 km/10, 5*1.5 km/10]=600 to 750 m. As yet another example, if the detector segment 302j receives the return spot of the ranging pulse, the system can estimate the range to the object that reflected the ranging pulse as [9*1.5 km/10, 10*1.5 km/10]=1.35 km to 1.5 km.

As the foregoing example illustrates, when the segmented detector 300 is configured as described above, the resolution of the above-described triangulation-based range calculation is equal to the transceiver's range divided by the number of detector segments. For many applications of interest, the range resolution afforded by the above-described triangulation-based range calculation is not sufficient unless the detector has an impractical length L_{D} and/or an impractical number of detector segments.

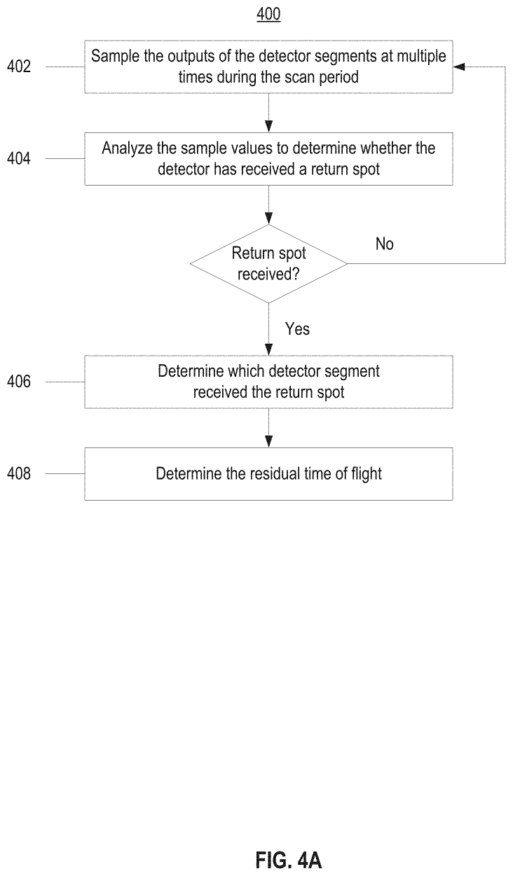

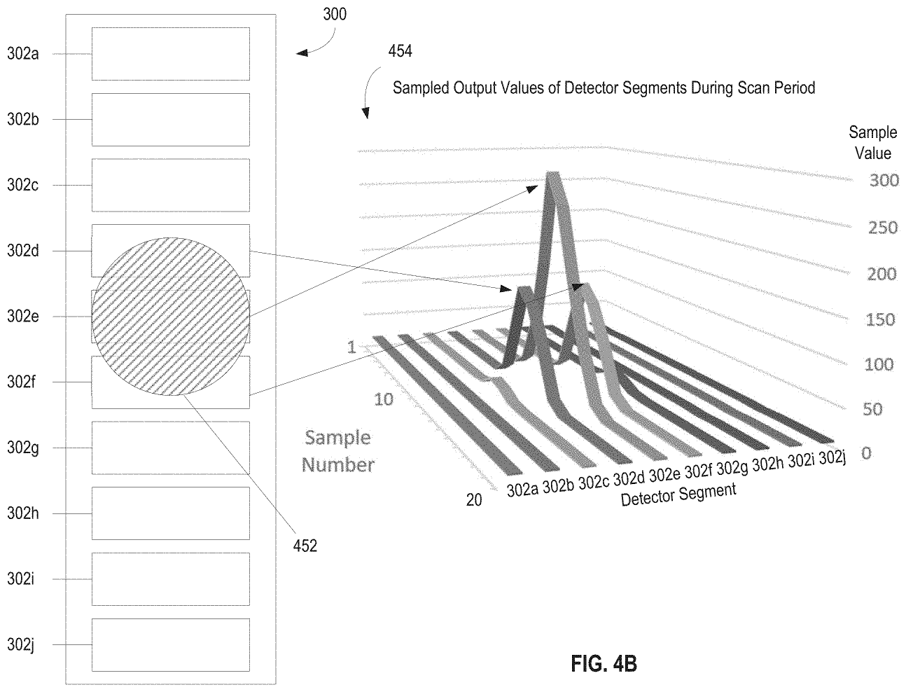

In some embodiments, the range resolution of the triangulation-based range calculation may be significantly improved by using interpolation to resolve the position of the center of the return spot to a location more precise than ‘somewhere between the outer boundaries of a specific detector segment.’ Referring to FIG. 4B, in many cases portions of a return spot may be received by two or more segments of the segmented detector. In such cases, the output values of the segments that receive portions of the return spot may generally increase as the proportion of the segment that is covered by the return spot increases. For example, the output values of the segments may be proportional to the proportion of the segment covered by the return spot. By interpolating among the segments' outputs, the position of the center of the return spot may be resolved to a specific location ‘det_loc’ along the length of a specific detector segment. (For example, a value of 4.5 for det_loc indicates that the center of the return spot is approximately halfway between the upper and lower boundaries of the detector segment with index=4.) The distance D to the object can then be estimated as follows:

D=det_loc*R/num_det.

In some embodiments, the range resolution of the segmented detector may be further improved by using a triangulation-augmented time-of-flight (ToF) calculation to determine the distance D to an object as follows:

D=min_distance+residual_distance

=(det_index*R/num_det)+residual_ToF*c/2,

where min_distance is the minimum distance to the object (which may be determined using triangulation) and residual_distance is the residual_distance to the object (which may be determined using time-of-flight analysis). When the detector is configured as described above, the minimum distance to the object may be calculated as det_index*R/num_det, where det_index is the index of the detector segment that receives the return spot, R is the transceiver's maximum range, and num_det is the number of detector segments. The residual distance to the object may be calculated as residual_ToF*c/2, where residual_ToF is the residual time of flight of the transmitted and return beams, and c is the speed of light in the medium through which the transmitted and return beams travel. Conceptually, the residual time of flight is the additional time of flight of the transmitted and return beams beyond the time of flight required for the transmitted and return beams to traverse the minimum distance (min_distance) between the transceiver and the object. The residual time of flight (residual_ToF) may be calculated by determining the difference between the return time of the return beam and the transmission time of the most-recently transmitted ranging pulse.

While scanning the field of view, the transceiver may use any suitable method to detect the receipt of a return spot by the segmented detector 300, determine which of the detector segments 302 has received the return spot, and/or determine the residual time of flight of the transmitted beam and return beam that produced the return spot. Referring to FIG. 4A, a method 400 for detecting return spots with a segmented optical detector may include operations 402-408, some embodiments of which are described below. Using the detection method 400 to detect return spots may enable LiDAR devices to fire their ranging pulses at a much faster rate than LiDAR devices that use conventional detection techniques. Thus, LiDAR devices that use the detection method 400 may be able to scan their fields of view much more quickly and/or with much finer resolution than conventional LiDAR devices. Alternatively, LiDAR devices that use the detection method 400 may be able to scan a large field of view in the same amount of time that a conventional LiDAR device scans a much smaller field of view at the same resolution. In some embodiments, a LiDAR device using the detection method 400 may be able to scan a large field of view (e.g., 40 degrees by 40 degrees) quickly (e.g., in 1 second) with gapless coverage in the scan lines.

In operation 402, the device controller samples the electrical signals (e.g., currents or voltages) output by each of the detector segments 302 at multiple times during the scan period. The controller may digitize the sampled values (e.g., using an analog-to-digital converter or “ADC”) and store them (e.g., in a computer-readable storage medium). To facilitate subsequent determinations of residual times of flight, the controller may store additional information in connection with the samples, for example, the start time of the scanning period (e.g., the transmission time of the most recently transmitted ranging pulse), the times when the samples are taken, the sample numbers, the durations of the sample periods, etc. The outputs of the detector segments 302 may be sampled any suitable number of times during the scan period (e.g., 5-500 times or more). The sample periods may be uniform or non-uniform.

In operation 404, the device controller may analyze the sample values collected during the scan period and determine, based on those sample values, whether the detector has received a return spot. In some embodiments, this analysis may involve comparing the sample values to a detection threshold value and determining that the detector has received a return spot if any of the sample values exceeds a detection threshold value. Otherwise, the device controller may determine that no return spot has been received. In some embodiments, this analysis may involve performing pattern analysis on the set of sample values to determine whether the sample values conform to one of a plurality of stored patterns. If the sample values conform to a pattern representing receipt of a return spot, the device controller may determine that the detector has received a return spot. Otherwise, the device controller may determine that no return spot has been received.

If the device controller determines that the detector received a return spot during the scan period, the controller may determine (406) which detector segment received the return spot. In some embodiments, the controller identifies the detector segment that produced the highest sample value during the scan period as the detector segment that received the return spot. In some embodiments, if the sample values conform to a pattern representing receipt of a return spot by a particular detector segment, the controller identifies that detector segment as the segment that received the return spot.

Also, if the device controller determines that the detector received a return spot during the scan period, the controller may determine (408) the residual time of flight of the transmitted beam and the return beam that produced the return spot. In some embodiments, assuming the samples in each scan period are numbered sequentially and the sample period T_sample is uniform, the controller may determine the residual time of flight to be the product of (1) the sample number of the sample that produced the highest sample value during the scan period and (2) the duration of the sample period T_sample. In some embodiments, if the sample values conform to a pattern representing receipt of a return spot during a particular sample period, the controller may determine the residual time of flight to be the product of (1) the sample number of that sample period and (2) the duration of the sample period T_sample.

Although not shown in FIG. 4A, after identifying the detector segment that received the return spot and determining the residual time of flight, the controller may perform a triangulation-augmented time-of-flight (ToF) calculation to determine the distance D to the object that reflected the return beam.

Referring to FIG. 4B, examples of return spot detection and triangulation-augmented time-of-flight (ToF) determination operations are illustrated. FIG. 4B depicts an example of a segmented detector 300, a return spot 452, and a graph 454 showing values read from the detector segments 302 during the scan period. In the example of FIG. 4B, the maximum range of the transceiver is 1.5 km, the number of detector segments is 10, the return spot is centered on detector segment 302e, with portions of the return spot also spilling over onto detector segments 302d and 302f. Also, in the example of FIG. 4B, the duration of the scan period is 1 μs, the outputs of the detector segments 302 are sampled 20 times per scan period, and the sample periods are uniform (1 μs/20 samples=50 ns/sample).

Across all the samples taken from all the detector segments, the peak output value of detector segment 302e is highest (and is above a detection threshold value), indicating that detector segment 302e received the return spot during the scan period. Furthermore, the peak output value of the detector segment 302e occurs during the 14th sampling period, indicating that detector receives the return spot 14*50 ns=700 ns after the start of the scan period. Using this information, the LiDAR device can determine the distance to the object that reflected the return signal as follows:

D=min_distance+residual_distance

=(det_index*R/num_det)+residual_ToF*c/2

=4*1.5 km/10+700 ns*c/2

=600 m+105 m=705 m.

Whereas the resolution of the triangulation-based range calculation may be limited by the number of detector segments or the precision of an interpolation calculation, the resolution of the triangulation-augmented ToF range calculation is limited by the sample period. In this example, the resolution of the triangulation-augmented ToF range calculation is 50 ns*c/2=7.5 m, a significant improvement over the resolution of the triangulation-based range calculation. In some embodiments, the duration of the sample period may be between 0.1 ns and 100 ns (e.g., 1 ns). With a 1 ns scan period, the resolution of the triangulation-augmented ToF range calculation in the foregoing example would be approximately 1 ns*c/2=150 mm.

In rare cases, a segmented detector may receive two or more return spots on two or more different detector segments during the same sampling period. Such “collisions” may be processed using any suitable technique. For example, during analysis 402 of the sample values, all sample values other than the highest sample value may be discarded, thereby ignoring the weaker return signals in favor of the strongest return signal. Alternatively, during analysis 402 of the sample values, the presence of a collision may prevent the set of sample values from matching (or closely matching) any stored pattern of sample values. As a result, the controller may discard the sample values for the scan period, assign a low confidence value to any distance calculated for the scan period, or otherwise discount the sample values obtained during the scan period in which the collision occurs.

An example has been described in which the range R of a LiDAR transceiver is 1.5 km the transceiver's segmented detector has 10 segments. More generally, design parameters for some embodiments of a LiDAR scanner may be selected in accordance with the following parameters and constraints:
‘R’ is the desired range of the LiDAR scanner (e.g., 1.5 km);
‘M²’ is the scanner's laser beam quality (e.g., 1.3);
‘λ’ is the laser wavelength (the wavelength of the beams transmitted by the scanner (e.g., 1300 nm);
‘ω₀’ is the half-width of the scanner's collimating lens (e.g., 25 mm);
the beam divergence ‘θ’=M²*λ/(π*ω₀) (e.g., 2.152*10⁻⁵ radians);
the spot size of the transmitted laser beam at the maximum range ‘SpotSize’=2*θ*R (e.g., 64.6 mm);
‘Φ’ is the desired minimum diameter of objects to be detected by the scanner (e.g., 4 inches);
‘PRF’ is the pulse repetition frequency of the transmitter (e.g., 1 MHz);
‘FF’ is the desired spot fill factor of the transmitted beams (e.g., 50%);
the maximum change in the transmission angle of successive scanning beams ‘γ’=θ*(1−FF) (e.g., 1.076*10⁻⁵ radians);
the angular scanning speed (e.g., the angular rate of rotation of movable mirror 256)=‘ω’=γ*PRF (e.g., 10.76 radians/s);
‘vFOV’ is the desired vertical field of view (e.g., 20 degrees);
the time required to scan one scan line in the vertical field of view ‘vFperiod’=vFOV/ω (e.g., 0.032 s);
the maximum frequency at which scan lines in the vertical field of view can be scanned ‘vFrate’=1/vFperiod (e.g., 30.822 Hz);
the time of flight for the ranging pulse and the return beam at the desired range of the scanner ‘TF’=2*R/c (e.g., 10.0 μs);
the angular walk-off of the scanner at maximum range (e.g., the change in angular position of the scanner's optical component during the time of flight TF) ‘ang_walk’=ω*TF (e.g., 107.6*10⁻⁶ radians);
the linear walk-off of the return spot at maximum range ‘lin_walk’=ang_walk/θ (e.g., 5.0 spot widths);
‘Det’ is the size of the detector (e.g., 20 μm);
the angular aperture of the focusing lens ‘Ap’=2*ω₀ (e.g., 50 mm);
‘Fnum’ is the f-number of the collimating lens (e.g., 40);
the effective focal length of the collimating lens ‘EFL’=Fnum*Ap (e.g., 2 m);
the size of a return spot ‘DetSpot’=Det/EFL (e.g., 10*10⁻⁶ radians);
the ratio of the size of a return spot to the walk off of the return spot at maximum range is DetSpot/ang_walk (e.g., 0.093); and
the ratio of the size of a return spot to the beam divergence is DetSpot/θ (e.g., 0.465).

In some embodiments, the scan spots are significantly overlapped to ensure that objects with diameters as small as 4 inches (e.g., utility lines and guide wires) do not evade detection. For example, the fill factor of the scan spots may be between 40% and 60%.

In some embodiments, a bright, single-mode laser may be used to facilitate long-range scans. For example, the transceiver's laser may be a fiber laser with a wavelength of approximately 1300-1310 nm.

In some embodiments, the pulse repetition frequency is relatively high (e.g., 1-2 MHz) and the scan rate is 30-60 Hz.

In some embodiments, the maximum detection range is 1.5 km, the detector length is 20-25 μm, the number of detector segments is 10, and the effective focal length of the receiver lens is 2 meters, such that the 10 detector segments span the time-of-flight walk-off over the 1.5 km range.

In some embodiments, the scan lines are scanned bi-directionally rather than uni-directionally. For example, if the scan lines are vertical, the scanner may scan one scan line from top to bottom and another scan line from bottom to top. To support bi-directional scanning, the length of the detector and the number of detector segments may be approximately doubled, such that half the detector segments are used for scanning in one direction, and the other half of the detector segments are used for scanning in the opposite direction.

In some embodiments, the peak laser power to range a relatively dark target (e.g., a utility line having a diffuse reflectivity of 10%) at 1.5 km using a 1300 nm fiber laser is approximately 10-20 kW. Assuming the transmitted beams have 3 ns pulses, the average laser power may be approximately 30-60 W.

In some embodiments, a transceiver 102a may be configured to scan a 40 degree by 40 degree field of view in 1 second using 30 vertical scan lines. The horizontal resolution of the scan may be 40 degrees/30=1.33 degrees. The spot size may be approximately 22 microradians and the spot pitch may be approximately 11 microradians, such that the scan lines have no gaps and a fill factor of 50%.

In some embodiments, a transceiver 102b may be configured to scan a 40 degree by 40 degree field of view in 1 second using 30 horizontal scan lines. The vertical resolution of the scan may be 40 degrees/30=1.33 degrees. The spot size may be approximately 22 microradians and the spot pitch may be approximately 11 microradians, such that the scan lines have no gaps and a fill factor of 50%.

In some embodiments, the two transceivers 102a and 102b may be configured to scan the same 40 degree by 40 degree field of view simultaneously, thereby scanning the field of view with a grid of gapless lines and a grid spacing of 1.33 degrees.

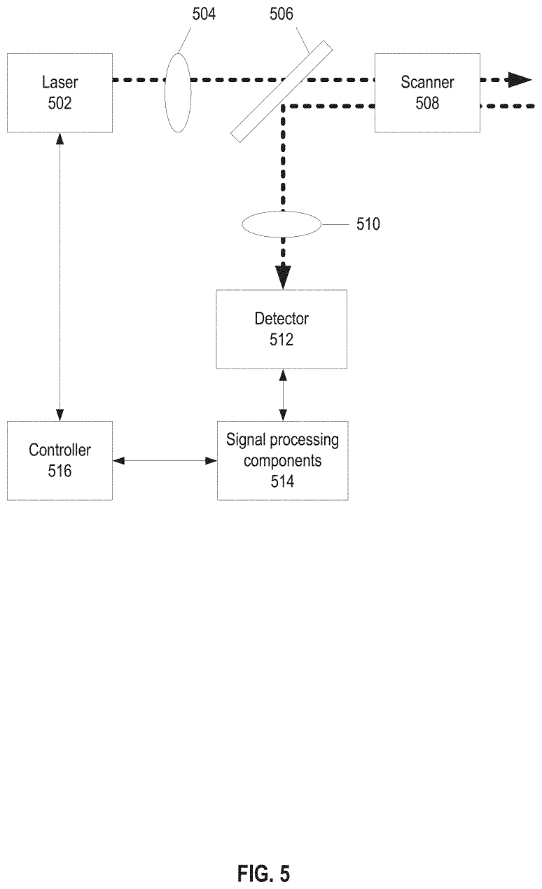

Referring to FIG. 5, a long-range, high-resolution LiDAR transceiver 500 may include a laser 502, transmission optics 504, a combiner 506, a scanner 508, return optics 510, a detector 512, signal processing components 514, and a controller 516.

In some embodiments, the laser 502 may be a fiber laser operable to transmit laser beams at wavelengths of 1300-1310 nm. The peak laser power may be 10-20 kW, and the average laser power may be 30-60 W.

In some embodiments, the scanner 508 is operable to scan a 40 degree by 40 degree field of view in 1 second using 30 vertical scan lines or 30 horizontal scan lines. Some embodiments have been described in which the scanner's scan mechanism is a resonant and servomotor-controlled 2D scan mirror. In some embodiments, the scanner's scan mechanism may be a rotating polygon with angled facets.

In some embodiments, the detector 512 may be a segmented detector 300. More generally, the detector 512 may be any suitable optical detector having multiple discrete sense nodes distributes along the detector's length. In the case of the segmented detector 300, the detector segments 302 are the discrete sense nodes. Alternatively, a continuous detector tapped at discrete locations along the detector's length may be used. In that case, the taps are the discrete sense nodes.

In some embodiments, the signal processing components 514 may include a readout circuit operable to read out the values of the detector segments 302 during each sample period, a preamplifier circuit operable to amplify the values read out of the detector segments, and an analog to digital converter (ADC) operable to digitize the sampled values. In some embodiments, the ADC has 2×10 channels with 10 bits per channel.

In some embodiments, the controller 516 controls the firing of the laser 502, performs the operations of the detection method 400, and determines the distances to objects using triangulation-augmented time-of-flight calculations.

In some embodiments, a LiDAR system may include two long-range, high-resolution LiDAR transceivers 500a and 500b configured to simultaneously scan the system's field of view in orthogonal directions.

In some embodiments, a LiDAR system may include an object classification module, which may use computer vision and/or machine learning techniques to classify objects in the system's field of view based on the system's scan results. For example, the object classification module may be configured to classify utility lines, guide wires, radio towers, etc. In some embodiments, a LiDAR system may include an obstacle detection module, which may use computer vision and/or machine learning techniques to detect obstacles in the path of a vehicle and provide feedback to the vehicle controller to mitigate collision or create a motion plan. For example, power lines or tree branches in the path of the vehicle may be detected, and the locations of these obstacles may be used by the vehicle's control system to avoid collisions or by a motion planner to determine trajectories around the obstacles.

In some embodiments, a LiDAR system may include a power and communication link. The average power used by the LiDAR system (including two transceivers 500a and 500b, object classification module, and power and communication link) may be less than 200-400 Watts. The size of the LiDAR system may be approximately 0.5 m×0.5 m×0.25 m.

### System Embodiments

In embodiments, aspects of the techniques described herein may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

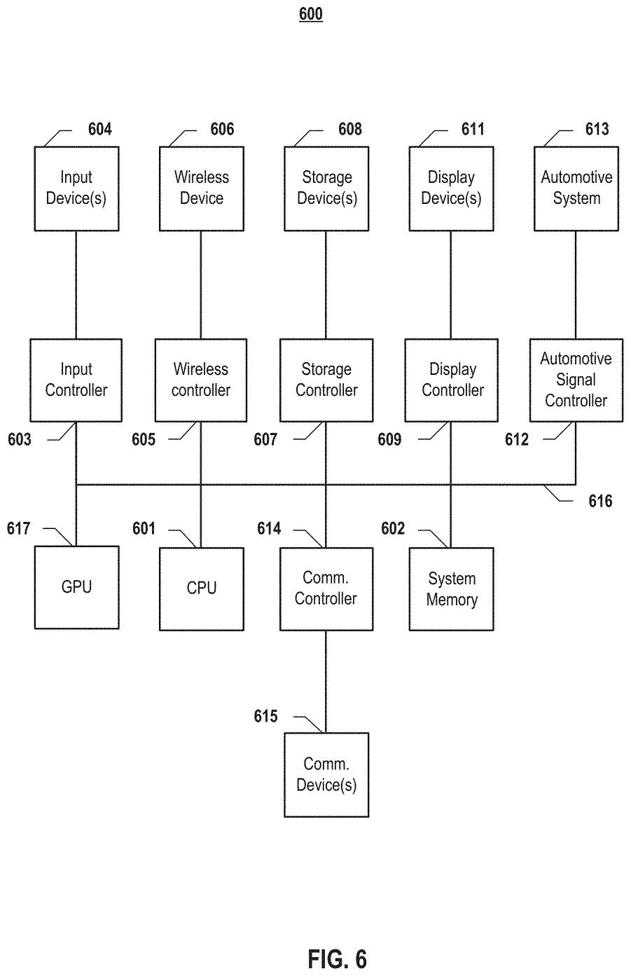

FIG. 6 depicts a simplified block diagram of a computing device/information handling system (or computing system) according to embodiments of the present disclosure. It will be understood that the functionalities shown for system 600 may operate to support various embodiments of an information handling system—although it shall be understood that an information handling system may be differently configured and include different components.

As illustrated in FIG. 6, system 600 includes one or more central processing units (CPU) 601 that provides computing resources and controls the computer. CPU 601 may be implemented with a microprocessor or the like, and may also include one or more graphics processing units (GPU) 617 and/or a floating point coprocessor for mathematical computations. System 600 may also include a system memory 602, which may be in the form of random-access memory (RAM), read-only memory (ROM), or both.

A number of controllers and peripheral devices may also be provided, as shown in FIG. 6. An input controller 603 represents an interface to various input device(s) 604, such as a keyboard, mouse, or stylus. There may also be a scanner controller 605, which communicates with a scanner 606. System 600 may also include a storage controller 607 for interfacing with one or more storage devices 608 each of which includes a storage medium such as magnetic tape or disk, or an optical medium that might be used to record programs of instructions for operating systems, utilities, and applications, which may include embodiments of programs that implement various aspects of the techniques described herein. Storage device(s) 608 may also be used to store processed data or data to be processed in accordance with some embodiments. System 600 may also include a display controller 609 for providing an interface to a display device 611, which may be a cathode ray tube (CRT), a thin film transistor (TFT) display, or other type of display. The computing system 600 may also include an automotive signal controller 612 for communicating with an automotive system 613. A communications controller 614 may interface with one or more communication devices 615, which enables system 600 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that have computer code thereon for performing various computer-implemented operations. The media and computer code may be those specially designed and constructed for the purposes of the techniques described herein, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A LiDAR-based sensor system, comprising:
an optical transmitter;
a scanner;
a segmented optical detector including a plurality of discrete sense nodes distributed along a length of the segmented optical detector; and
a controller,
wherein the optical transmitter is operable to transmit a ranging signal via an optical component of the scanner,
wherein the scanner is operable to change a position and/or orientation of the optical component after the ranging signal is transmitted via the optical component and before a return signal corresponding to the ranging signal is received,
wherein the segmented optical detector is operable to receive the return signal corresponding to the ranging signal via the optical component after the change in the position and/or orientation of the optical component, and the controller is operable to detect a location of a return spot of the return signal based on outputs of one or more of the discrete sense nodes, and
wherein the controller is operable to determine a distance to an object that reflected the return signal based, at least in part, on (1) the location of the return spot and (2) a residual time of flight of the return signal.

2. The system of claim 1, wherein the ranging signal includes a plurality of pulses in sequence.

3. The system of claim 1, wherein a pulse repetition frequency of the optical transmitter is between 1 MHz and 2 MHz.

4. The system of claim 1, wherein the scanner is operable to scan a 40 degree by 40 degree field of view at a range of 1.5 km in 1 second or less using gapless scan lines.

5. The system of claim 4, wherein the scanner is configured to scan the gapless scan lines bi-directionally.

6. The system of claim 1, wherein the scanner comprises a resonant and servomotor-controlled 2D scan mirror or a rotating polygon with angled facets.

7. The system of claim 1, wherein the optical component of the scanner comprises a movable mirror.

8. The system of claim 1, wherein the optical transmitter is operable to transmit the ranging signal, via the optical component of the scanner, to a first scan point of a plurality of scan points.

9. The system of claim 8, wherein the scanner is operable to change a position and/or orientation of the optical component after the ranging signal is transmitted via the optical component and before the return signal corresponding to the ranging signal is received by:
moving the optical component of the scanner to an orientation associated with a second scan point of the plurality of scan points during a ranging period of the first scan point, the ranging period including at least a time period between the optical transmitter transmitting the ranging signal and the optical detector the return signal.

10. The system of claim 1, wherein an angular scanning speed of the scanner is between 10 and 12 radians/second and a range of the sensor system is at least 1.5 km.

11. The system of claim 10, wherein a length of the segmented optical detector is between 20 and 25 μm and the plurality of discrete sense nodes includes 8-12 discrete sense nodes.

12. The system of claim 1, wherein the optical transmitter includes a fiber laser with a wavelength of between 1300-1310 nm.

13. The system of claim 1, wherein the LiDAR-based sensor system is a component of or is configured to communicate with a navigation system of a helicopter, an airplane, an unmanned aerial vehicle, or a watercraft.

14. The system of claim 13, wherein the object is a guide wire or utility line having a diameter of at least 4 inches, and wherein the controller is further configured to identify the object as a guide wire or utility line.

15. The system of claim 1, wherein the optical transmitter, the scanner, and the segmented optical detector are components of a first LIDAR channel operable to scan a field of view of the LIDAR-based sensor system in a first direction, and wherein the LIDAR-based sensor system further comprises a second LIDAR channel operable to scan the field of view in a second direction orthogonal to the first direction.

16. The system of claim 15, wherein the second LIDAR channel includes a second optical transmitter, a second scanner, and a second segmented optical detector including a second plurality of discrete sense nodes distributed along a length of the second segmented optical detector

17. A LiDAR-based sensing method, comprising:
(a) by an optical transmitter and via an optical component of a scanner of a LIDAR device, transmitting a ranging signal toward a first scan point of a plurality of scan points;
(b) changing a position and/or orientation of the optical component of the scanner after the ranging signal is transmitted via the optical component;
(c) after changing the position and/or orientation of the optical component of the scanner, receiving a return signal reflected from the first scan point, wherein the return signal is received via the optical component of the scanner and by a segmented optical detector including a plurality of discrete sense nodes distributed along a length of the segmented optical detector;
(d) detecting, by a controller, a location of a return spot of the return signal based on outputs of one or more of the discrete sense nodes; and
(e) determining, by the controller, a distance to the first scan point based, at least in part, on (1) the location of the return spot and (2) a residual time of flight of the return signal.

18. The method of claim 17, wherein the ranging signal includes a plurality of pulses in sequence.

19. The method of claim 17, further comprising scanning a 40 degree by 40 degree field of view at a range of 1.5 km in 1 second or less using gapless scan lines by repeating steps (a)-(e) a plurality of times.

20. The method of claim 19, wherein scanning the field of view using gapless scan lines comprises scanning the gapless scan lines bi-directionally.

21. The method of claim 17, further comprising identifying a guide wire or utility line having a diameter of at least 4 inches in a field of view of the LIDAR device based on the outputs of the plurality of discrete sense nodes.

22. A method comprising:
by a segmented optical detector including a plurality of discrete sense nodes distributed along a length of the segmented optical detector, generating a plurality of electrical signals during a ranging period of a scan point, wherein each electrical signal in the plurality of electrical signals corresponds to a respective discrete sense node in the plurality of discrete sense nodes and represents an optical signal sensed by the respective discrete sense node; and
by a controller:
receiving the plurality of electrical signals generated by the segmented optical detector;
sampling the plurality of electrical signals of the segmented optical detector at multiple times during the ranging period, thereby generating a plurality of sampled values;
determining, based on the plurality of sampled values, whether the segmented optical detector has received a return spot; and
when the controller determines that the segmented optical detector has received the return spot,
determining which of the plurality of discrete sense nodes of the segmented optical detector received the return spot;
determining a residual time of flight of a return signal corresponding to the return spot; and
determining a distance to a scan point from which the return signal was reflected based, at least in part, on (1) which of the plurality of discrete sense nodes received the return spot and (2) the residual time of flight of the return signal.

23. The method of claim 22, further comprising storing, by the controller, additional data indicating at least one of: a start time of the ranging period, a plurality of times when the plurality of electrical signals are sampled, and/or durations of one or more sampling periods.

24. The method of claim 22, wherein determining whether the segmented optical detector has received the return spot includes comparing the plurality of sampled values to a detection threshold value.

25. The method of claim 22, wherein determining whether the segmented optical detector has received the return spot includes performing pattern analysis on the plurality of sampled values to determine whether the plurality of sampled values conform to any of a plurality of stored patterns.

26. The method of claim 22, wherein the determining which of the plurality of discrete sense nodes of the segmented optical detector received the return spot is based on an identification of a particular discrete sense node of the plurality of discrete sense nodes producing a highest sampled value during the ranging period as the discrete sense node that received the return spot.

27. The method of claim 22, wherein the distance to the scan point is determined using a triangulation-augmented time-of-flight calculation.

28. A LIDAR-based receiver system, comprising:
a segmented optical detector including a plurality of discrete sense nodes distributed along a length of the segmented optical detector, the segmented optical detector being configured to generate a plurality of electrical signals during a ranging period of a scan point, wherein each electrical signal in the plurality of electrical signals corresponds to a respective discrete sense node in the plurality of discrete sense nodes and represents an optical signal sensed by the respective discrete sense node; and
a controller configured to:
receive the plurality of electrical signals generated by the segmented optical detector;
sample the plurality of electrical signals of the segmented optical detector at multiple times during the ranging period, thereby generating a plurality of sampled values;
determine, based on the plurality of sampled values, whether the segmented optical detector has received a return spot; and
when the controller determines that the segmented optical detector has received the return spot,
determine which of the plurality of discrete sense nodes of the segmented optical detector received the return spot;
determine a residual time of flight of a return signal corresponding to the return spot; and
determine a distance to a scan point from which the return signal was reflected based, at least in part, on (1) which of the plurality of discrete sense nodes received the return spot and (2) the residual time of flight of the return signal.

29. The system of claim 28, wherein the distance to the scan point is determined using a triangulation-augmented time-of-flight calculation.

30. The system of claim 28, wherein a length of the segmented optical detector is between 20 and 25 μm and the plurality of discrete sense nodes includes 8-12 discrete sense nodes.
